(19) United States
(12) Patent Application Publication
(10) Pub. No.: US 2009/0003843 A1
(43) Pub. Date: Jan. 1, 2009

(54) Optical transmitter and method for control the same

(76) Inventor: Hirotaka Oomori, Yokohama-shi (JP)

Correspondence Address: SMITH, GAMBRELL & RUSSELL, 1130 CONNECTICUT AVENUE, N.W., SUITE 1130, WASHINGTON, DC, 20036, US

(21) Appl. No.: 12/213,211

(22) Filed: Jun. 16, 2008

(30) Foreign Application Priority Data
Jun. 19, 2007 (JP) 2007-161698

(51) Int. Cl. H04B 10/04; H04B 10/12

(52) U.S. Cl. 398/197; 398/192; 372/34

(57) ABSTRACT

An optical transmitter that reduces the stimulated Brillion scattering occurred within a transmission optical fiber and a method to control the optical transmitter are disclosed. The optical transmitter with a type of the chirp managed laser diode (CML) comprises a laser diode modulated with a high frequency signal and biased with a relatively large bias current and an optical filter. When the modulation signal is stopped, an optical signal with relatively large power and narrow spectrum may enter the transmission fiber, which causes the stimulated Brillouin scattering. In the present optical transmitter, when the modulation signal is absent, an auxiliary signal is superposed on the bias current.

### BACKGROUND OF THE INVENTION

1. Field of the Invention

The present invention relates to an optical transmitter and a method to control this optical transmitter.

2. Related Prior Arts

It has been known that an optical communication system with relatively long distance will be realized by the CML technique, “Chirp managed directly modulated laser diode”, that effectively reduces the transient chirp. Matsui, et al. and Mahgerefteh, et al. have reported this technique in IEEE Photonics Technology Letters, p 385, vol. 18 (2), Jan. 15, 2006 and Electronics Letters, vol. 41(9), Apr. 28, 2005, respectively. This CML technique may reduce the transient chirp by directly driving a laser diode (hereafter denoted as LD) with relatively large bias current and relatively small modulation current, and may secure an extinction ratio by cutting optical components corresponding to the status “0” by an optical notch filter with a quite narrow eliminating-band.

However, when the laser diode is free from the modulation, that is, the modulation signal provided to the transmitter becomes off, an optical signal with a quite large peak power and a narrow spectrum enters the optical fiber, which causes the stimulated Brillouin scattering within the transmission fiber. Once the Brillouin scattering occurs, the optical power reaching the optical amplifier that is ordinarily installed in the midway of the transmission line decreases and the optical amplifier tries to adjust its optical gain so as to keep the optical output therefrom constant, which causes the saturation of the amplifier, or affects the transmission status of the normally operating signal channels in the wavelength division multiplexing (WDM) system.

### SUMMARY OF THE INVENTION

Therefore, one aspect of the present invention is to provide an optical transmitter that reduces both the transient chirp and the stimulated Brillouin scattering occurred within the transmission optical fiber, and to provide a method to control the optical transmitter.

An optical transmitter according to the present invention comprises an LD to emit light, a bias unit to provide a bias current to the LD, an LD driver to modulate the LD with a high frequency modulation signal, a signal generator to provide an auxiliary signal to the bias unit, an optical filter to filter the light from the LD and to enter the filtered light to the optical fiber, and a controller to control the bias unit and the LD driver. The optical transmitter of the invention has a feature that, when the LD becomes free from the high frequency modulation signal, that is, when the LD is stopped to be modulated with the high frequency signal, the controller sends a command to the signal generator so as to provide the auxiliary signal to the bias unit and another command to the LD driver so as to stop the provision of the high frequency signal to the LD, then, the bias unit provides the bias current superposed with the auxiliary signal provided from the signal generator.

The optical transmitter of the present invention may further provide a detector to detect whether the light output from the LD is normally modulated with the high frequency modulating signal or not. This detection is performed by detecting a time variation of a difference between the maximum and the minimum of the light output from the LD. When the detector decides that the LD is not modulated with the high frequency modulation signal, the detector sends a control signal to the controller, and the controller carries out the same operation above mentioned, that is, the controller sends commands to the LD driver so as to stop the provision of the high frequency signal to the LD and to the signal generator to send the auxiliary signal to the bias unit.

The optical transmitter of the present invention may further provide another detector to detect whether the LD is normally modulated with the high frequency modulation signal or not. This detection is performed by detecting a time variation of a light output from the LD and reflected by the optical filter. When the other detector decides that the LD is not modulated with the high frequency modulation signal, the other detector sends a control signal to the controller, and the controller carries out the same operation above mentioned.

Another aspect of the invention relates to a method to control the optical output of the optical transmitter. The method comprising steps of: (1) detecting a state of the high frequency modulation signal provided to the LD, (2) when a state that provision is stopped, the controller sends commands to the LD driver so as to stop the provision of the high frequency modulation signal to the LD, and to the signal generator so as to provide the auxiliary signal to the bias unit, and (3) the bias unit provides the bias current superposed with the auxiliary signal.

In the present invention, the step (1) to detect the state of the high frequency modulation signal may be preformed by receiving a command from a host system, by detecting the time variation of the difference between the maximum and the minimum of the light output from the LD, or by detecting the time variation of the light output from the LD and reflected by the optical filter.

### BRIEF DESCRIPTION OF DRAWINGS

FIG. 1 schematically illustrates a functional block diagram of an optical transmitter according to the first embodiment of the invention;

FIG. 2 is a flow chart showing an operation of the optical transmitter in FIG. 1;

FIG. 3 schematically illustrates a functional block diagram of an optical transmitter according to the second embodiment of the invention;

FIG. 4 is a flow chart showing an operation of the optical transmitter in FIG. 3;

FIG. 5 schematically illustrates a functional block diagram of an optical transmitter according to the third embodiment of the invention; and

FIG. 6 is a flow chart showing an operation of the optical transmitter in FIG. 5.

### DESCRIPTION OF PREFERRED EMBODIMENTS

Next, preferred embodiments according to the present invention will be described as referring to accompanying drawings. In the description of the drawings, the same symbols or the same numerals will refer to the same elements without overlapping explanations.

### First Embodiment

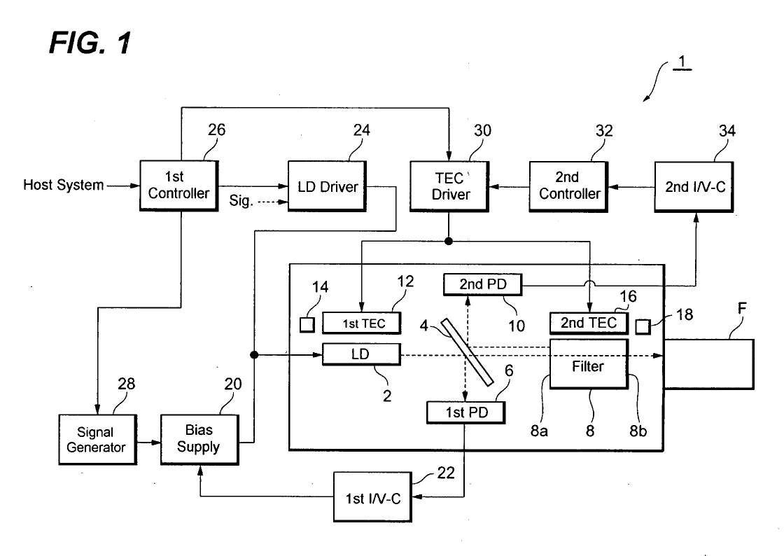

FIG. 1 schematically illustrates a functional block diagram of an optical transmitter according to the first embodiment of the invention. The optical transmitter 1, which is one type of the CML device, comprises an LD 2, an optical splitter 4, a first photodiode (hereafter denoted as PD) 6, an optical filter 8, a second PD 10, a first thermo-electric cooler (hereafter denoted as TEC) 12, a first thermistor 14, a second TEC 16 and a second thermistor 18. This optical transmitter 1 may electrically communicate with a host system, and may optically couple with an optical fiber F.

The LD 2 is a type of, what is called, a distributed feedback laser diode (DFB-LD), and may emit the light by being provided with a bias current supplied from the bias unit 20. The signal light output from the LD 2 enters the optical fiber F passing through the optical splitter 4 and the optical filter 8. The optical splitter 4, arranged on the optical axis between the LD 2 and the optical fiber F, splits the signal light output from the LD 2 into two beams, one of which enters the optical filter 8, while, the other of which is guided to the first PD 6. Also, this optical splitter 4 reflects light from the optical filter 8, which is a reflected light, to the second PD 10.

The first PD 6 monitors a first portion of the light output from the LD 2 and split by the optical splitter 4 and generates a first photocurrent that indicates the monitored light and outputs it to the first current-to-voltage converted (hereafter denoted as I/V-C) 22. The optical filter 8, arranged between the optical splitter 4 and the fiber F, transmits a portion of the light with wavelengths specific to the optical filter 8 and guides this filtered light to the fiber F. That is, the optical filter 8 is a band eliminating filter with a narrow notch band to cut only components corresponding to the signal “0”. The light output from the LD 2 includes components corresponding to both state “1” and state “0”. The second PD 10 monitors the light reflected by the optical filter 8, which is a second portion of light, generates a second photocurrent indicating the monitored result and outputs it to the second I/C-C 34.

The first and second TECs, 12 and 16, control temperatures of the LD 2 and the optical filter 8, respectively. They are driven by the TEC driver 30.

The first and second thermistors, 14 and 18, monitor the temperatures of the LD 2 and the optical filter 8. So, the first thermistor 14 is arranged just beside the LD 2 on the first TEC 12, while, the second thermistor 18 is arranged immediate to the optical filter 8 on the second TEC 18.

The optical transmitter 1 further comprises, as an electronic function, the bias unit 20, the first I/V-C 22, the LD driver 24, the first controller 26, the signal generator 28, the TEC driver 30, the second controller 32 and the second I/V-C 32. The bias unit 20 supplies the bias current with relatively large magnitude compared with conventional applications to the LD 2. The first I/V-C 22 converts the first photocurrent output from the first PD 6 into a voltage signal and sends it to the bias unit 20. The bias unit 20, based on this voltage signal from the first I/V-C 22, adjusts the bias current for the LD 2 so as to keep the optical power output from the LD 2 constant.

The LD driver 24, responding to a command from the first controller 26, provides the modulation current to the LD 2. This modulation current reflects the signal to be transmitted and contains components corresponding to the status “0” and the status “1”. The LD driver 24 may receive a command directly from the host system without the first controller 26.

The first controller 26 controls the LD driver 24. The first controller 26, when it receives a command from the host system to stop the optical output from the transmitter 1, or to stop the modulation of the LD 2, the controller 26 outputs a control signal reflecting this command from the host system to the LD driver 24. The LD driver 24, when it receives this control signal from the first controller 26, stops to provide the modulation signal to the LD 2.

The first controller 26 also controls the signal generator 28. Receiving the command above mentioned from the host system, the first controller 26 outputs a command to the signal generator 28, where the command from the first controller 26 includes a procedure for the signal generator to output an auxiliary signal with frequencies from several kirohertz to some thirty or forty mega-hertz, with a duty ratio of 50%, and with an amplitude enough to turn on and off the LD 2. The signal generator 28, responding to the command from the first controller 26, outputs this auxiliary signal to the bias unit 20, and the bias unit 20 superposes this auxiliary signal on the bias current to provide thus superposed current to the LD 2.

The first controller 26 controls the signal generator 28 to supply the auxiliary signal only when the LD driver 24 does not provide the high frequency modulation signal to the LD2. In a case where the high frequency signal and the auxiliary signal are both provided to the LD 2, the light output from the LD 2 disorders the peak wavelengths each corresponding to the status “0” and status “1”, which fluctuates the extinction ratio of the signal light. Thus, the optical transmitter 1 according to the present embodiment may effectively prevent this disordering of the peak wavelengths in the optical output therefrom.

The first controller 26 also controls the TEC driver 30. Receiving the command to stop the modulation from the host system, the first controller 26 sends a command to the TEC driver 30 so as to change the protocol to control a temperature of the LD 2. The TEC driver 30 controls the temperature of the LD 2 based on the management of the second controller 32 when the LD driver 24 provides the high frequency modulation signal to the LD 2, which is called as the first protocol. While, when the LD driver 24 stops the high frequency modulation signal, the TEC driver 30 controls the temperature of the LD 2 based on a monitored signal output from the first thermistor 14, which is called as the second protocol.

The TEC driver 30 generates a control signal to control the first TEC so as to keep the temperature of the LD 2 constant based on the monitored signal from the first thermistor 14 when it manages the temperature of the LD 2 based on the second protocol. Specifically, the TEC driver 30, when the protocol to control the temperature of the LD is switched from the first one to the second one, the TEC driver 30 generates a control signal provided to the first TEC 12 such that the temperature of the LD 2 after the switching is kept at a temperature when the protocol is just switched.

The second controller 32, when the TEC driver 30 controls the temperature of the LD 2 based on the first protocol above, generates a control signal to the TEC driver 30 based on the monitored result obtained from the second PD through the second I/V-C 34 so as to keep the magnitude of the light reflected by the optical filter 8, or to keep a ratio of the magnitude of the light monitored with the first PD to the magnitude of the light monitored with the second PD. The second I/V-C 34 converts the photocurrent output from the second PD, which indicates the magnitude of the reflected light by the optical filter 8, into a voltage signal and sends it to the second controller 32.

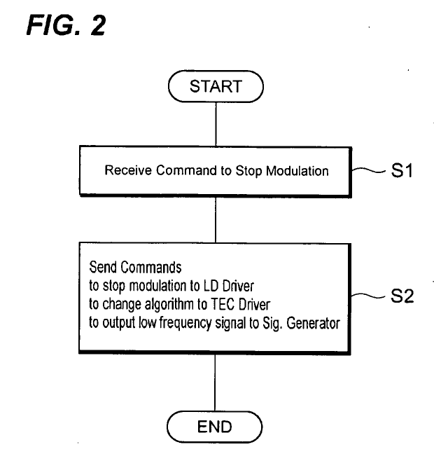

Next, the operation of the optical transmitter 1 will be described as referring to FIG. 2, which is a flow chart to illustrate procedures in the optical transceiver 1. We assume a situation that the LD driver 24 provides the high frequency modulation signal to the LD 2 and the TEC driver 30 controls the temperature of the LD 2 based on the first protocol mentioned above.

The first controller 26, when it receives the command to stop the modulation signal provided to the LD 2 at step S1, sends commands (1) to stop the modulation, (2) to change the protocol to control the temperature of the LD 2, and (3) to provide the auxiliary signal to the LD driver 24, the TEC driver 30, and the signal generator 28, respectively, at step S2. Then, the LD driver 24 stops the provision of the modulation signal, and the TEC driver 30 changes the protocol. Further, the signal generator 28 provides the auxiliary signal to the bias unit 20 where this auxiliary signal is superposed with the bias current to be provided to the LD 2. Thus, according to the present embodiment, because the LD 2 is modulated with the auxiliary signal even when the host system sends the command to stop the modulation, the optical output from the transmitter 1 may be kept its modulation by the auxiliary signal, which prevents the Brillouin scattering in the fiber and, accordingly, the irregular operation of the optical amplifier installed in the midway of the transmission line.

### Second Embodiment

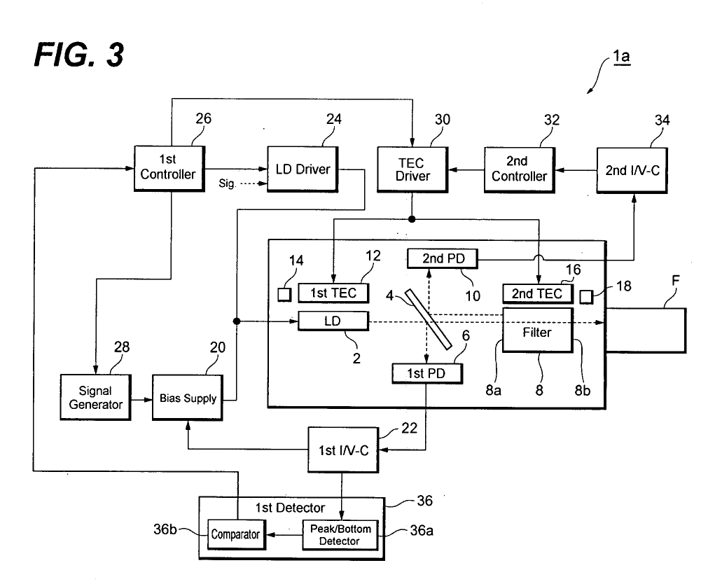

Next, a second embodiment of the optical transmitter 1a according to the present invention will be described. FIG. 3 schematically illustrates a functional block diagram of the optical transmitter 1a. This optical transmitter 1a further comprises a first detector 36 in addition to those of the first transmitter 1 shown in FIG. 1. The first detector 36 includes a peak/bottom detector 36a and the first comparator 36b. The first I/V-C 22 outputs the voltage signal corresponding to the first photocurrent generated by the first PD 6 to both the bias unit 20 and the peak/bottom detector 36a.

The peak/bottom detector 36a monitors the peak value and the bottom value of the voltage signal provided from the first I/V-C 22 with a preset period, and calculates the time variation of the difference between the peak and the bottom values, which we call the first variation. This first variation reflects the variation of the difference between the maximum and the minimum output power emitted from the LD 2 and monitored by the first PD 6. The peak/bottom detector 36a sends this calculated result to the first comparator 36b.

The first comparator 36b, based on thus calculated result by the peak/bottom detector 36a, decides whether the LD 2 is modulated with the modulation signal or not. When the LD 2 is un-modulated, the first variation becomes zero. The first comparator 36b, when it decides the first variation is in the case where the LD 2 is un-modulated with the modulation signal, generates a control signal that indicates the un-modulated LD 2 to the first controller 26.

The first controller 26, when it receives this control signal from the first comparator 36b, sends commands to change the protocol to control the temperature of the LD to the TEC driver 30 and to output the auxiliary signal to the signal generator 28, respectively, similar to the operation of the optical transmitter 1 according to the aforementioned first embodiment. When the bias current superposes the modulation signal thereon, the auxiliary signal is not superposed on the bias current. When both signals are concurrently superposed on the bias current, the peak wavelengths each corresponding to the status “0” and the status “1” disorders and the extinction ratio of the optical output of the transmitter 1a fluctuates. According to the optical transmitter 1a shown in FIG. 3, such disordering in the peak wavelengths and the fluctuation in the extinction ratio may be prevented.

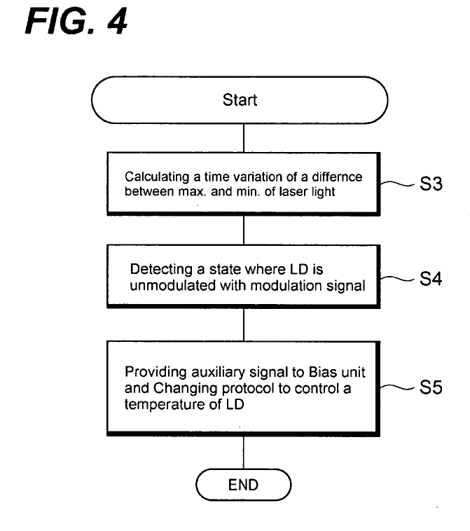

Next, an operational flow of the optical transmitter 1a will be described as referring to FIG. 4. We assume a case where the LD 2 receives the modulation signal from the LD driver 24, and the TEC driver 30 controls the temperature of the LD 2 under the first protocol. In this condition, the peak/bottom detector 36a calculates the time variation of the difference between the peak and bottom values both monitored by the first PD 6, at step S3. Then, the first comparator decides whether the LD 2 is modulated with the modulation signal or not, at step S4. When the first comparator 36b decides that the time variation of the difference between the peak and the bottom value is in a condition when the LD 2 is un-modulated, the first comparator 36b sends the control signal to the first controller 26 so as to stop the provision of the modulation current. When the first comparator 36b decides that the first variation is in the range where the LD 2 regularly receives the modulation signal, the optical transmitter 1a iterates the process of steps S3 and S4.

After step S4 above described, receiving the control signal from the first comparator 36b, the first controller 26 sends commands to change the protocol for controlling the temperature of the LD 2 from the first one to the second one to the TEC driver, and to output the auxiliary signal to the signal generator 28, at step S5. Then, the TEC driver 30 changes the protocol, the signal generator 28 outputs the auxiliary signal to the bias unit 20, and the bias unit 20 superposes the auxiliary signal on the bias current to provide thus superposed driving signal to the LD 2.

According to the optical transmitter 1a of the present embodiment, even when the LD driver 24 suspends the provision of the high frequency modulation signal to the LD 2 under the condition that relatively large bias current is provided thereto to reduce the transient chirp, the auxiliary signal may be provided to the LD 2 from the bias unit 20. Accordingly, the optical output from the transmitter 1a may be kept in the wavelength spectrum of the optical output thereof by the auxiliary signal, which prevents the Brillouin scattering within the transmission fiber and, accordingly, the irregular operation of the optical amplifier installed in the midway of the transmission line.

### Third Embodiment

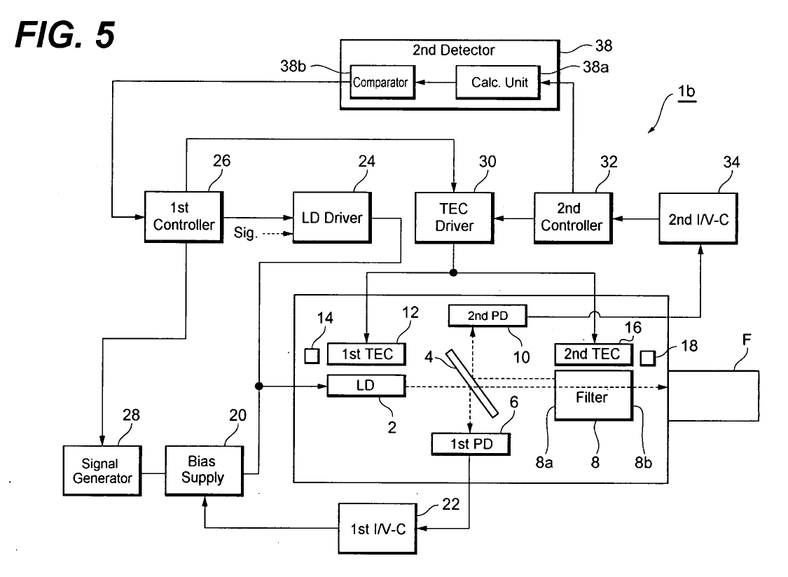

Next, the third embodiment of the optical transmitter according to the present invention will be described as referring to FIG. 5 that schematically illustrates the functional block diagram of the optical transmitter 1b. This optical transmitter 1b further comprises a second detector 38 in addition to those provided in the first transmitter shown in FIG. 1. The second detector 38 includes a calculating unit 38a and the second comparator 38b. The second I/V-C 43 converts the second photocurrent generated by the second PD 10 into the voltage signal and sends this voltage signal to both the second controller 32 and the calculating unit 38a.

The calculating unit 38a calculates a time variation, which we call as the second variation, of the voltage signal sent from the second I/V-C 34. The second variation indicates the time variation of the light reflected by the optical filter 8 which is monitored by the second PD 10. The calculating unit 38a sends the second variation to the second comparator 38b.

The second comparator 38b decides, based on the calculated results, whether the second variation is in a range where the modulation signal is not provided to the LD 2. When the LD 2 does not receive the modulation signal, the second variation becomes zero. When the second comparator 38b decides that the LD 2 does not receive the modulation signal, a control signal that indicates the state of the LD 2 is output to the first controller 26.

The first controller 26, similar to the aforementioned optical transmitters, 1 and 1a, sends commands so as to change the protocol for controlling the temperature of the LD 2 to the TEC driver 30 and so as to output the auxiliary signal to the signal generator 28, respectively. Thus, the first controller 26 controls the signal generator 28 so as to output the auxiliary signal only when the modulation signal is not provided to the LD 2. When both signals are provided to the LD 2, that is, the LD 2 is modulated with a signal containing high frequencies and also low frequencies, the peak wavelengths each corresponding to the status “0” and the status “1” disorders, which causes the fluctuation of the extinction ratio of the optical output. However, the optical transmitter 1b according to the present embodiment may prevent the fluctuation of the peak wavelengths.

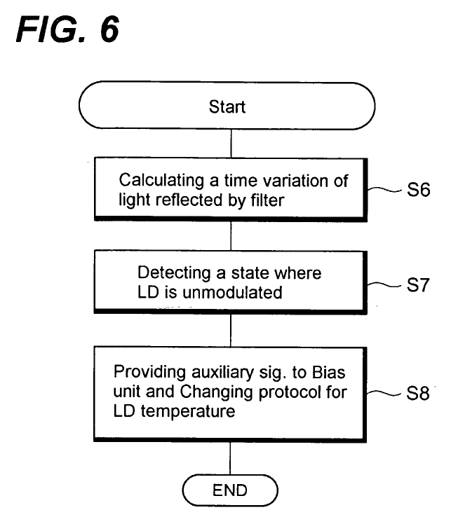

Next, an operational flow of the optical transmitter 1b will be described as referring to FIG. 6. We assume a case where the LD 2 is provided with the modulation signal from the LD driver 24 and its temperature is controlled by the first protocol.

Under such a condition, the calculating unit 38a calculates the second variation of the light reflected by the optical filter 8 at step S6. Next, the second comparator 38b decides, based on the calculated second variation, whether the LD 2 receives the modulation signal or not at step S7. That is, the second comparator 38b decides whether the second variation is within a range that indicates a condition where the LD 2 receives the modulation signal, or not. When the second variation is out of the range, that is, the LD 2 receives the modulation signal, the operation iterates steps S6 and S7 until the second variation becomes within the range.

After step S7, the first controller 26 sends commands to the TEC driver 30 so as to change the protocol from the first one to the second one and to the signal generator 28 so as to output the auxiliary signal to the bias unit 20, and the bias unit 20 superposes this auxiliary signal on the bias current, at step S8. The bias unit 20 provides this superposed driving signal to the LD 2.

According to the optical transmitter 1b of the present embodiment, even when the LD driver 24 suspends the provision of the modulation signal to the LD 2 under the condition that relatively large bias current is provided thereto to reduce the transient chirp, the auxiliary signal may be provided to the LD 2 from the bias unit 20. Accordingly, the optical output from the transmitter 1b may be kept in the wavelength spectrum thereof by the auxiliary signal, which prevents the Brillouin scattering within the transmission fiber and, accordingly, the irregular operation of the optical amplifier installed in the midway of the transmission line.

While, the preferred embodiments of the present invention have been described in detail above, many changes to these embodiments may be made without departing from the true scope and teachings of the present invention. The present invention, therefore, is limited only as claimed below and the equivalents thereof.

What is claimed is:

1. An optical transmitter installed on a host system comprising:
a laser diode to emit light;
a first driver to drive said laser diode with a modulation signal;
a bias unit to provide a bias current to said laser diode;
an optical notch filter to eliminate a portion of said light;
a signal generator to generate an auxiliary signal; and
a controller configured to send a command to said signal generator so as to send said auxiliary signal to said bias unit when said controller receive a control signal to stop said modulation of said laser diode.

2. The optical transmitter according to claim 1,
wherein said control signal is supplied from said host system.

3. The optical transmitter according to claim 1,
further comprising a first detector to detect a time variation of a difference between a peak value and a bottom value of a first portion of said light emitted from said laser diode,
wherein said first detector generates said control signal to be received by said controller when said time variation of said difference is in a range where said laser diode is un-modulated.

4. The optical transmitter according to claim 3,
further comprising a first photodiode and an optical splitter,
wherein said optical splitter splits said light emitted from said laser diode into two beams, one of said two beams being detected by said first photodiode as said first portion of said light, and the other of said two beams entering said optical filter.

5. The optical transmitter according to claim 1,
further comprising a second detector to detect a time variation of a second portion of said light emitted said laser diode and reflected by said optical filter,
wherein said second detector generates said control signal to be received by said controller when said time variation of said second portion of said light is in a range where said laser diode is un-modulated.

6. The optical transmitter according to claim 5,
further comprising a second photodiode to detect said second portion of said light reflected by said optical filter.

7. The optical transmitter according to claim 1,
wherein said auxiliary signal has a frequency smaller than a frequency of said modulation signal, a duty cycle of about 50% and an enough magnitude to fully turn on and off said laser diode.

8. The optical transmitter according to claim 1,
wherein said light emitted from said laser diode shows two peak wavelengths each corresponding to a state “0” and to a state “1” of said modulation signal when said laser diode is modulated with said modulation signal.

9. The optical transmitter according to claim 1,
further comprising a first thermo-electric cooler with a thermistor to control a temperature of said laser diode, a second thermoelectric cooler to control a temperature of said optical filter, a second driver to drive said first and second thermo-electric coolers, a second controller to control said second driver, a first photodiode to detect a first portion of said light emitted from said laser diode, and a second photodiode to detect a second portion of said light emitted from said laser diode and reflected by said optical filter,
wherein said second driver controls said first thermo-electric cooler and said second thermo-electric cooler under a control of said second controller so as to keep a ratio of said first portion of said light to said second portion of said light constant when said laser diode is modulated with said modulation signal.

10. The optical transmitter according to claim 9,
wherein said first controller further sends a command to said second driver so as to control said temperature of said first thermo-electric cooler based on an output of said thermistor when said laser diode is un-modulated with said modulation signal.

11. A method to control an optical transmitter that emits signal light with two peak wavelengths each corresponding to a state “0” and to a state “1”, said signal light being output from a laser diode by being supplied with a modulation signal superposed on a bias current and filtered with an optical notch filter to eliminate a signal component corresponding to said state “0”, comprising steps of:
(a) detecting whether said laser diode is un-modulated with said modulation signal or not; and
(b) when said laser diode is un-modulated, providing an auxiliary signal superposed on said bias current to said laser diode.

12. The method according to claim 11,
wherein said laser diode is controlled in a temperature thereof based on a first portion of said light emitted from said laser diode and a second portion of said light emitted from said laser diode and reflected by said optical filter when said laser diode is modulated with said modulation signal, and
said method further comprising a step of, when said laser diode is un-modulated with said modulation signal, controlling said temperature of said laser diode independent of said light emitted from said laser diode.

13. The method according to claim 11,
wherein said detection whether said laser diode is modulated or not is performed by detecting a time variation of a difference between a peak value and a bottom value of said light emitted from said laser diode.

14. The method according to claim 11,
wherein said detection whether said laser diode is modulated or not is performed by detecting a time variation of said light emitted from said laser diode and reflected by said optical filter.

15. The method according to claim 11,
wherein said detection whether said laser diode is modulated or not is performed by receiving a signal from said host system.
